(19) United States
(12) Patent Application Publication
(10) Pub. No.: US 2004/0010358 A1
(43) Pub. Date: Jan. 15, 2004

(54) Vehicle personalization through web portal

(75) Inventors: Christopher L. Oesterling, Troy, MI (US); Thomas A. Gawlik, Rochester Hills, MI (US)

Correspondence Address: General Motors corporation, Mail Code 482-C23-B21, 300 Renaissance Center, P.O. Box 300, Detroit, MI, 48265-3000, US

(73) Assignee: General Motors Corporation

(21) Appl. No.: 10/193,799

(22) Filed: Jul. 12, 2002

(51) Int. Cl. G06F 17/00

(52) U.S. Cl. 701/49; 701/1

(57) ABSTRACT

The present invention provides a method and system of personalizing settings for a telematics unit in a mobile vehicle. At least one user preference is received at a call center via a web portal interface, and is sent from the call center to the telematics unit. A vehicle function is activated based on the user preference. Another aspect of the invention provides a computer usable medium that includes program code to personalize settings for a telematics unit in a mobile vehicle.

### FIELD OF THE INVENTION

This invention relates generally to wireless communications with a mobile vehicle. More specifically, the invention relates to a system and method for personalizing parameters and functions of a telematics unit in a mobile vehicle.

### BACKGROUND OF THE INVENTION

The opportunity to personalize features in a mobile vehicle is ever increasing as the automobile is being transformed into a communications and entertainment platform as well as a transportation platform. Many vehicles now have hundreds of personalization settings such as seat and mirror positions, door lock/unlock behavior, radio station present selections, climate controls, custom button configurations and theft alarm settings. With projections that by 2006 almost all new American cars will have some level of telematics service, most vehicles will require customization or personalization of wireless vehicle communication, networking, maintenance and diagnostic services. Controller systems may be configured or updated in a manner similar to software updates. Even liquid crystal (LCD) displays on the dashboard may be reconfigurable with changes on which data is on the center screen and which is relegated to side panels. For example, it is possible to rearrange dashboard displays for the speedometer, global positioning system (GPS), map navigation, cell phone, two-way radio, maps, radio presets, and mirror and seating settings.

The number and complexity of configurations leads to sometimes confusing and complicated menu selections accessed by combinations of button pushing or series of voice commands. The complexity of configuring so many settings is requiring an easier, user-friendlier way for an owner of an automobile to personalize, update or change personal settings. Additionally, those who lease, rent or drive more than one vehicle need to have an easy way to transfer their vehicle setting preferences from vehicle to vehicle.

It is an object of this invention, therefore, to provide a system and method to personalize vehicle parameters and functions of communication, networking, maintenance and diagnostic services in a user-friendly and efficient way, and to overcome the challenges and obstacles described above.

### SUMMARY OF THE INVENTION

The present invention provides a method and system of personalizing settings for a telematics unit in a mobile vehicle. At least one user preference is received at a call center via a web portal interface and sent from the call center to the telematics unit. A vehicle function may be activated based on the user preference. Another aspect of the invention provides a computer usable medium that includes program code to personalize settings for a telematics unit in a mobile vehicle.

The aforementioned, and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates one embodiment of a system for personalizing settings of an in-vehicle telematics unit, in accordance with the current invention;

FIG. 2 illustrates another embodiment of a system for personalizing settings of an in-vehicle telematics unit, in accordance with the current invention;

FIG. 3 is a flow diagram of one embodiment of a method of personalizing settings for an in-vehicle telematics unit, in accordance with the current invention; and

FIG. 4 is a flow diagram of another embodiment of a method of personalizing settings for an in-vehicle telematics unit, in accordance with the current invention.

### DETAILED DESCRIPTION OF THE PRESENTLY PREFERRED EMBODIMENTS

With the present invention, a driver can personalize a vehicle via a user-friendly website, alleviating the complexity of configuring vehicle personalization and communication features with a series of buttons or voice-activated commands in a mobile vehicle. In addition, the driver can preset seat positions, dashboard displays, radio-station buttons, temperature controls and other configurable features or functions of an automobile or truck before ever entering the vehicle.

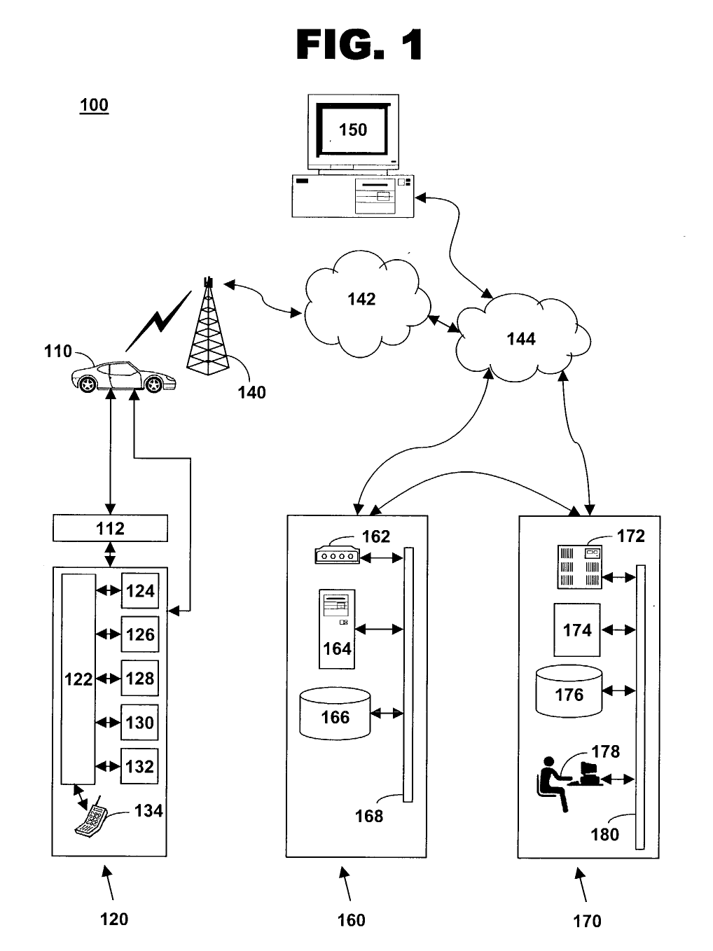

FIG. 1 illustrates one embodiment of system for personalizing settings of an in-vehicle telematics unit, in accordance with the present invention at 100.

Vehicle personalization system 100 for personalizing settings of an in-vehicle telematics unit includes a mobile vehicle 110, a vehicle communication bus 112, a telematics unit 120, one or more wireless carrier systems 140, one or more communication networks 142, one or more land networks 144, one or more client, personal or user computers 150, one or more web-hosting portal 160, and one or more call centers 170. Mobile vehicle 110 may be a mobile vehicle equipped with suitable hardware and software for transmitting and receiving voice and data communications.

Telematics unit 120 may include a digital signal processor (DSP) 122 connected to a wireless modem 124, a global positioning system (GPS) unit 126, an in-vehicle memory 128, a microphone 130, one or more speakers 132, and an embedded or in-vehicle mobile phone 134. DSP 122 may also be referred to as a microcontroller, controller, host processor, or vehicle communications processor. GPS unit 126 may provide longitude and latitude coordinates of the vehicle. In-vehicle mobile phone 134 may be an analog, digital, dual-mode, dual-band, multi-mode or multi-band cellular phone.

DSP 122 may execute various computer programs that control programming and operational modes of electronic and mechanical systems within mobile vehicle 110. DSP 122 may control communications between telematics unit 120, wireless carrier system 140, and call center 170. A voice-recognition application may be installed in DSP 122 that can translate human voice input through microphone 130 to digital signals. DSP 122 may generate and accept digital signals transmitted between telematics unit 120 and a vehicle communication bus 112 that is connected to various electronic modules in the vehicle. These digital signals may activate the programming mode and operation modes, as well as provide for data transfers. Signals from DSP 122 may be translated into voice messages and sent out through speaker 132.

Mobile vehicle 110, via a vehicle communication bus 112, may send signals to various units of equipment and systems within mobile vehicle 110 to perform various functions such as unlocking a door, opening the trunk, setting personal comfort settings, and calling from telematics unit 120. In facilitating interactions among the various communication and electronic modules, vehicle communication bus 112 may use bus interfaces such as controller-area network (CAN), International Organization for Standardization (ISO) Standard 9141, ISO Standard 11898 for high-speed applications, and ISO Standard 11519 for lower speed applications.

Mobile vehicle 110 via telematics unit 120 may send and receive radio transmissions from wireless carrier system 140. Wireless carrier system 140 may be any suitable system for transmitting a signal from mobile vehicle 110 to communication network 142.

Communication network 142 may comprise services from one or more mobile telephone switching offices and wireless networks. Communication network 142 may connect wireless carrier system 140 to land network 144. Communication network 142 may be any suitable system or collection of systems for connecting wireless carrier system 140 to mobile vehicle 110 and land network 144.

Land network 144 is a public-switched telephone network. Land network 144 may be an Internet protocol (IP) network. Land network 144 may be comprised of a wired network, an optical network, a fiber network, another wireless network, or any combination thereof. Land network 144 is connected to one or more landline telephones. Land network 144 may connect communication network 142 to user computer 150, web-hosting portal 160, and call center 170. Communication network 142 and land network 144 may connect wireless carrier system 140 to web-hosting portal 160 and call center 170.

Client, personal or user computer 150 may include a computer usable medium to execute Internet browser and Internet-access computer programs for sending and receiving data over land network 144 and optionally, wired or wireless communication networks 142 to web-hosting portal 160. Personal or user computer 150 sends driver preferences to web-hosting portal through a web-page interface using communication standards such as hypertext transport protocol (HTTP), and transport-control protocol and Internet protocol (TCP/IP). The data may include directives to change certain programming and operational modes of electronic and mechanical systems within mobile vehicle 110. A driver may use user computer 150 to initiate setting or re-setting of user-preferences for mobile vehicle 110. User-preference data from client-side software may be transmitted to server-side software of web-hosting portal 160. User-preference data may be stored at web-hosting portal 160.

Web-hosting portal 160 comprises one or more data modems 162, one or more web servers 164, one or more databases 166, and a bus system 168. Web-hosting portal 160 may be connected directly by wire to call center 170, or connected by phone lines to land network 144, which is connected to call center 170. Web-hosting portal 160 may be connected to land network 144 by one or more data modems 162. Land network 144 sends digital data to and from modem 162, data that is then transferred to web server 164. Modem 162 may reside inside web server 164. Land network 144 may transmit data communications between web-hosting portal 160 and call center 170.

Web server 164 receives user-preference data from user computer 150 via land network 144. In alternative embodiments, user computer 150 may have a wireless modem to send data to web-hosting portal 160 through a wireless communication network 142 and a land network 144. Data are received by modem 162 and sent to one or more web servers 164. Web server 164 may be any suitable hardware and software capable of providing web services to help change and transmit personal preference settings from a driver at user computer 150 to telematics unit 120 in mobile vehicle 110. Web server 164 may send to or receive from one or more databases 166 data transmissions via bus system 168. Web server 164 includes computer applications and files for managing and storing personalization settings supplied by the driver, such as seat and mirror positions, door lock/unlock behavior, radio station present selections, climate controls, custom button configurations and theft alarm settings. For each user, the web server may store hundreds of preferences for wireless vehicle communication, networking, maintenance and diagnostic services for a mobile vehicle.

One or more web servers 164 may be networked via bus system 168 to distribute user-preference data among its network components such as database 166, which may be a part of or a separate computer from web server 164. Web server 164 sends data transmissions with user preferences to call center 170 via modem 162, and through land network 144.

Call center 170 is a location where many calls may be received and serviced at the same time, or where many calls may be sent at the same time. The call center may be a telematics call center, prescribing communications to and from telematics unit 120 in mobile vehicle 110. The call center may be a voice call center, providing verbal communications between an advisor in the call center and a subscriber in a mobile vehicle. The call center may contain each of these functions. Call center 170 and web-hosting portal 160 may be located in the same or different facility.

Call center 170 contains one or more voice and data switches 172, one or more communication services managers 174, one or more communication services databases 176, one or more communication services advisors 178, and one or more bus systems 180.

Switch 172 of call center 170 connects to land network 144. Switch 172 transmits voice or data transmissions from call center 170, and receives voice or data transmissions from telematics unit 120 in mobile vehicle 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more bus systems 180.

Communication services manager 174 is any suitable hardware and software capable of providing requested communication services to telematics unit 120 in mobile vehicle 110. Communication services manager 174 sends to or receives from one or more communication services databases 176 data transmissions via bus system 180. Communication services manager 174 sends to or receives from one or more communication services advisors 178 data transmissions via bus system 180. Communication services database 176 sends to or receives from communication services advisor 178 data transmissions via bus system 180. Communication services advisor 178 receives from or sends to switch 172 voice or data transmissions.

Communication services manager 174 may provide one or more of a variety of services, including enrollment services, navigation assistance, directory assistance, roadside assistance, business or residential assistance, information services assistance, emergency assistance, and communications assistance. Communication services manager 174 receives service-preference requests for a variety of services from the user via user computer 150, web-hosting portal 160, and land network 144. Communication services manager 174 transmits user-preference and other data to telematics unit 120 in mobile vehicle 110 through wireless carrier system 140, communication network 142, land network 144, voice and data switch 172, and bus system 180. Communication services manager 174 stores or retrieves data and information from communication services database 176. Communication services manager 174 may provide requested information to communication services advisor 178.

Communication services advisor 178 may be a real advisor or a virtual advisor. A real advisor is a human being in verbal communication with a user or subscriber in mobile vehicle 110 via telematics unit 120. A virtual advisor may be a synthesized voice interface responding to requests from telematics unit 120 in mobile vehicle 110.

Communication services advisor 178 provides services to telematics unit 120 in mobile vehicle 110. Services provided by communication services advisor 178 may include enrollment services, navigation assistance, real-time traffic advisories, directory assistance, roadside assistance, business or residential assistance, information services assistance, emergency assistance, and communications assistance. Communication services advisor 178 may communicate with telematics unit 120 in mobile vehicle 110 through wireless carrier system 140, communication network 142, and land network 144 using voice transmissions, or through communication services manager 174 and switch 172 using data transmissions. Switch 172 selects between voice transmissions and data transmissions.

Mobile vehicle 110 may initiate service request to call center 170 by sending a voice or digital-signal command to telematics unit 120 which in turn, sends an instructional signal or a voice call through wireless modem 124, wireless carrier system 140, communication network 142, and land network 144 to call center 170.

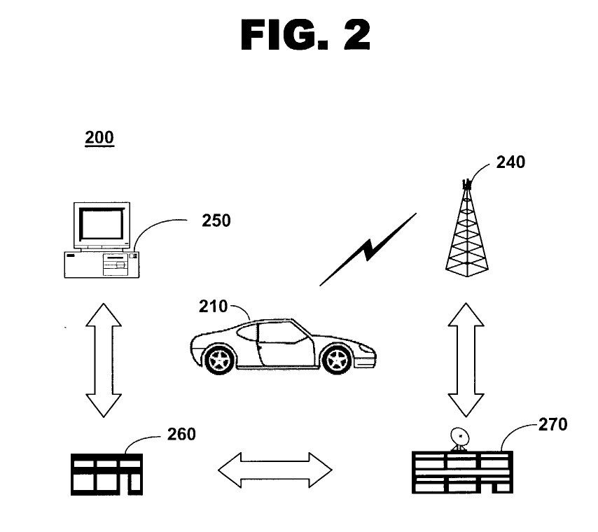

FIG. 2 illustrates another embodiment of a system of personalizing settings for an in-vehicle telematics unit, in accordance with the current invention. The vehicle personalization system 200 comprises one or more mobile vehicles 210, one or more wireless carrier systems 240, one or more user computers 250, one or more web-hosting portals 260, and one or more call centers 270.

A driver, subscriber or user of a mobile vehicle may use personal or user computer 250 to access the website of web-hosting portal 260. The website comprises web pages organized by vehicle function, features available on a particular vehicle model, part of the vehicle needing service update, last updated user preference or any other convenient and user-friendly way of presenting the current settings of user preferences and options for changing those preferences. The server-side software secures information through user identification numbers, vehicle identification numbers, passwords, or any other identification process to insure that a person is an authorized user of a telematics service to a particular vehicle.

Options are presented in an organized manner for easy selection, for example, by clicking a radio button, check box, selection box or drop-down menu. Server-side and optionally client-side form validation may be used to prevent the user from selecting unavailable, incorrect, or conflicting options of preferences. User preferences may include seat position preference, a mirror position preference, a door lock behavior preference, a radio station preset selection preference, a climate setting preference, a button configuration preference, and a theft alarm setting preference, as well as other preferences and user options in an ever-increasing list of telematics and vehicle services.

After new preferences have been selected, the user may be asked to verify new preferences and user identification again before the web-hosting portal 260 sends the final selections to call center 270.

The web-hosting portal 260 sends user-preference information to the communication services manager of call center 270. The call center processes a telematics service request with updated user preferences to the mobile vehicle via a combination of one or more types of networks and wireless carrier system 240.

The telematics unit of mobile vehicle 210 receives the updated user-preference information, and activates the functions that send signals to electronic controllers and equipment to change vehicle parameters and service settings that correspond to the user preferences sent to the vehicle. For example, the user-preference information may include seat-position, mirror-adjustment, radio-preset, dashboard-display, cell-phone and temperature-control settings that can be set before a driver ever enters a vehicle. The system depicted in FIG. 2 also illustrates the path of updated user-preference information being transmitted from mobile vehicle 210 back to web-portal interface at stored user preference from the telematics unit to the call center user computer 250. A driver may change one or more user preferences at mobile vehicle 210 where functions are activated to change vehicle parameters and settings to correspond to user preferences. The updated user-preferences are sent back to the call center, which in turn sends user-preference data to web-hosting portal 260. A driver may access information on the latest user-preference updates from the web-hosting portal via an Internet-connected personal computer. User preferences may be stored at the user or personal computer based on a user input at the mobile vehicle.

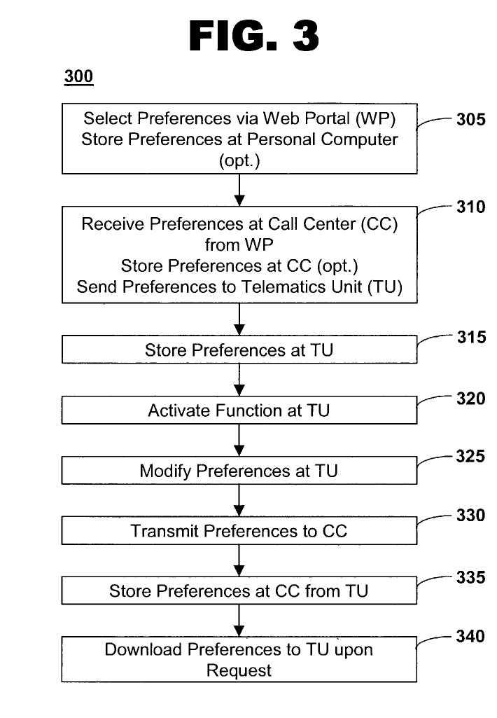

FIG. 3 is a flow diagram of one embodiment of a method of personalizing settings for an in-vehicle telematics unit, in accordance with the current invention. Vehicle personalization method 300 begins by the user selecting vehicle personalization preferences via web-hosting portal (WP), as seen at block 305. The preferences may be stored, if desired, in a local file at the personal computer. By storing the preferences locally, the user can access information on preferences without being connected to the web-hosting portal.

The call center receives at least one user preference via a web portal interface of the web-hosting portal as seen at block 310. When the user computer is connected to the Internet, information on previous settings is received through the web-hosting portal that accesses the preference data from the call center or from a frequently updated database of the portal.

The web-hosting portal or call center may update a user-preference profile in their databases based on the latest user-preference information sent from either the personal computer or the vehicle. The call center has the option of storing the data in its communicational services database at this point in the transmission of updated user preferences from the personal computer to the mobile vehicle. The call center then sends or transmits the updated user preferences to the telematics unit of the requested vehicle.

Information stored in a database at the user computer, web-hosting portal, or call center may affect the choices available to the user for selecting or modifying user preferences. The type of vehicle, vehicle options, or subscriber services plan may determine which options or preferences are currently available to the user. The stored information may be used to determine current settings for change.

After receiving the user-preference data, the telematics unit may store the preference information, as seen at block 315, and activate one or more vehicle functions based on user-preference information, as seen at block 320. The functions include but are not limited to a seat position, a mirror position, a door lock behavior, a radio station preset selection, a climate setting, a button configuration, and a theft alarm setting.

User preferences may also be modified at the vehicle, as seen at block 325 and then transmitted to the call center, as seen at block 330. The user preferences may be modified based on a voice command and associated voice recognition software, or any other suitable user interface including buttons. The preferences based on the user input at the mobile vehicle may be stored in the communication services database at the call center, as seen at 335. When requested, the call center can download the stored user preferences to the same or another mobile vehicle, as seen at 340. The call center may download the settings, for example, after a particular user enters the mobile vehicle. The call center may download the settings based on a verbal or button-based command. The preferences may be downloaded upon request of the subscriber, allowing a user to transfer preferences among owned, rented, or leased vehicles without a lengthy process of resetting preference settings in each vehicle. As long as a mobile vehicle is equipped with a compatible telematics system, a driver can download personalized settings into whatever vehicle the driver is using. The settings may be downloaded after extended loss of battery power in the mobile vehicle, when locally stored settings are lost or compromised.

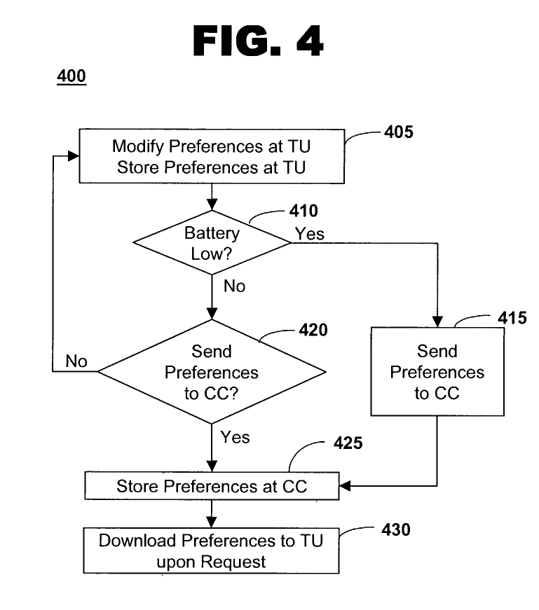

FIG. 4 is a flow diagram of another embodiment of a method of personalizing settings for an in-vehicle telematics unit, in accordance with the current invention.

Vehicle personalization method 400 begins with one or more user preferences being modified at the telematics unit, as seen at block 405. A preference may be modified based on a voice command. The preferences may be modified based on one or more button, touch-screen or voice-activated inputs, and stored in the telematics unit.

A vehicle battery powers the telematics unit and there may be times when battery power is running low, as seen at block 410. When the telematics unit or an electronic module in the vehicle which is monitoring the vehicle battery life detects that battery life or power drops below a predetermined threshold, the telematics unit can transmit one or all stored user preferences from the telematics unit to the call center, as seen at block 415. This ensures that the latest user preferences will not be lost when the telematics unit has no power, and that they can be downloaded again into the vehicle when power is regained.

Even when the power level for the telematics unit is sufficient, the user preferences may or may not be sent to the call center, as seen at block 420. If there is no instruction to send and update the user preferences at the call center, the telematics unit may wait for further instructions or wait until another modification has been made to the preferences, as seen back at block 405.

The telematics unit may wait for a scheduled communication time with the call center to update user preferences. For example, the communication time between the telematics unit and call center may be scheduled during periods of low network traffic. The preferences are sent to insure that the latest user preferences are available for downloading into the current vehicle or another vehicle that the driver could be driving. The driver also may choose to send updated user preferences to the call center or the telematics unit immediately after updating one or more user preferences in the vehicle.

Once the call center receives the updated information as a result of a low vehicle battery, a scheduled telematics unit update, or a driver-initiated update transmission, the call center stores the user preferences in its database, as seen at block 425. The database can store one or more sets of user preferences associated with each driver of a vehicle and one or more sets of user preferences per driver.

The call center may transmit one or more user preferences to the telematics unit based on a user input at the mobile vehicle. The preferences may be downloaded to a vehicle upon request, as seen at block 430. The call center downloads the preferences to the telematics unit of the vehicle that is being driven, allowing rapid recovery from loss of power or other unfavorable vehicle conditions.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of personalizing settings for a telematics unit in a mobile vehicle, comprising:
receiving at least one user preference at a call center via a web portal interface;
sending the user preference from the call center to the telematics unit; and
activating a vehicle function based on the user preference.

2. The method of claim 1 further comprising:
storing the user preference in the telematics unit.

3. The method of claim 1 further comprising:
storing the user preference at the call center or at a user computer.

4. The method of claim 3 further comprising:
transmitting at least one user preference from the call center to the telematics unit.

5. The method of claim 1 wherein the vehicle function is selected from the group consisting of a seat position, a mirror position, a door lock behavior, a radio station preset selection, a climate setting, a button configuration, and a theft alarm setting.

6. The method of claim 1 wherein the user preference is selected from a list consisting of a seat position preference, a mirror position preference, a door lock behavior preference, a radio station preset selection preference, a climate setting preference, a button configuration preference, and a theft alarm setting preference.

7. The method of claim 1 further comprising:
modifying the user preference through a user input at the mobile vehicle.

8. The method of claim 7 wherein the preference is modified based on a voice command.

9. The method of claim 7 further comprising:
transmitting the modified user preference to the call center.

10. The method of claim 2 further comprising:
monitoring battery life of a vehicle battery; and
transmitting the stored user preference from the telematics unit to the call center when the battery life drops below a predetermined threshold.

11. A computer usable medium including a program for personalizing settings for a telematics unit in a mobile vehicle, comprising:
computer program code to receive at least one user preference at a call center via a web portal interface;
computer program code to send the user preference from the call center to the telematics unit; and
computer program code to activate a vehicle function based on the user preference.

12. The computer usable medium of claim 11 further comprising:
computer program code to store the user preference in the telematics unit.

13. The computer usable medium of claim 11 further comprising:
computer program code to store the user preference at the call center or at a user computer.

14. The computer usable medium of claim 13 further comprising:
computer program code to transmit at least one user preference from the call center to the telematics unit.

15. The computer usable medium of claim 11 further comprising:
computer program code to modify the user preference through a user input at the mobile vehicle.

16. The computer usable medium of claim 15 further comprising:
computer program code to transmit the modified user preference to the call center.

17. The computer usable medium of claim 12 further comprising:
computer program code to monitor battery life of a vehicle battery; and
computer program code to transmit the stored user preference from the telematics unit to the call center when the battery life drops below a predetermined threshold.

18. A system for personalizing settings for a telematics unit in a mobile vehicle, comprising:
means for receiving at least one user preference at a call center via a web portal interface;
means for sending the user preference from the call center to the telematics unit; and
means for activating a vehicle function based on the user preference.

19. The system of claim 18 further comprising:
means for storing the user preference in the telematics unit.

20. The system of claim 18 further comprising:
means for storing the user preference at the call center or at a user computer.

21. The system of claim 20 further comprising:
means for transmitting at least one user preference from the call center to the telematics unit.

22. The system of claim 18 further comprising:
means for modifying the user preference through a user input at the mobile vehicle.

23. The system of claim 22 further comprising:
means for transmitting the modified user preference to the call center.

24. The system of claim 19 further comprising:
means for monitoring battery life of a vehicle battery; and
means for transmitting the stored user preference from the telematics unit to the call center when the battery life drops below a predetermined threshold.
